(19) United States
(12) Patent Application Publication
(10) Pub. No.: US 2018/0247261 A1
(43) Pub. Date: Aug. 30, 2018

(54) SYSTEM AND METHOD FOR TRACKING AND CHECKING IN DELIVERY DRIVERS

(71) Applicant: Wal-Mart Stores, Inc., Bentonville, AR (US)

(72) Inventors: Austin Smith, Burlingame, CA (US); Arnon Katz, San Mateo, CA (US); Michael Ebener, San Francisco, CA (US); Vidyanand Krishnan, Sunnyvale, CA (US); Deepak Deshpande, San Jose, CA (US); Prakash Seetharaman, Santa Clara, CA (US)

(21) Appl. No.: 15/445,337

(22) Filed: Feb. 28, 2017

(51) Int. Cl. G06Q 10/08

(52) U.S. Cl. CPC G06Q 10/0833

(57) ABSTRACT

A system includes a delivery server, an order server, and a database including consumer goods. The order server displays a website including the consumer goods to a customer and enables the customer to select consumer goods for purchase. The order server receives a request by the customer device to complete an order including the selected goods, receives a selection of a delivery time for the customer to receive the order, and transmits the order and delivery time to the delivery server. The delivery server receives a delivery acceptance notification indicating that a delivery driver has agreed to deliver the order to the customer. The delivery server also receives a check-in notification indicating that the delivery driver is estimated to arrive at the store in less than a threshold amount of time, and automatically places the order in a delivery queue for loading the order into the delivery vehicle.

### FIELD OF THE DISCLOSURE

The present invention relates to the remote ordering of goods or items by a customer that are to be assembled at a store or facility, and more particularly, to a system and method for tracking and checking in delivery drivers at a store.

### BACKGROUND

Many customers order items or goods remotely, e.g., online, through the Internet, or using a specially designed application or app on a mobile device, such as a tablet or cell phone. The customer may desire that the goods in the order be delivered to their home or that the goods in the order be assembled and ready for the customer to pick up at a specific location, e.g., a particular store, typically at a specific time.

If the customer selects an option to have the goods delivered to their home or another specified location, the store may assemble the goods and then send the order to a delivery department or delivery service to deliver the goods to the specified location. The store will typically not know when a delivery driver will arrive to pick up the order, however. The delivery driver may arrive at the store to pick up the order and may have to walk up to an employee to notify the store that the driver has arrived. At that point, the goods may be loaded into the vehicle to be delivered to the customer. However, this may result in wasted time. For example, time may be lost while the driver is waiting for the employee who is scheduled to load the order to be notified of the driver's arrival. In addition, miscommunication may arise and the proper employees may not be notified of the driver's arrival.

The present invention is aimed at one or more of the problems identified above.

### SUMMARY OF THE INVENTION

In one embodiment, a system for use in facilitating delivery of a customer order includes a delivery server, an order server, and a database including a plurality of consumer goods available for purchase by the customer, wherein the consumer goods are available at a retail store. The order server is configured to display a website including the plurality of consumer goods to a customer via a customer device and enable the customer to select at least one of the consumer goods for purchase. The order server is also configured to receive a request by the customer device to complete an order including the selected consumer goods, receive a selection of a delivery time for the customer to receive the order at a specified location, and transmit the order and the selected delivery time to the delivery server. The delivery server is configured to receive a delivery acceptance notification issued by a device of a delivery driver indicating that the delivery driver has agreed to deliver the order to the customer. The delivery server is also configured to receive a check-in notification indicating that the delivery driver is estimated to arrive at the retail store in less than a threshold amount of time, and automatically place the order in a delivery queue for loading the order into the delivery vehicle in response to the check-in notification.

In another embodiment, a method for facilitating delivery of a customer order includes providing a database including a plurality of consumer goods available for purchase by the customer, wherein the consumer goods are available at a retail store. The method also includes displaying, by an order server, a web site including the plurality of consumer goods to a customer via a customer device, and enabling, by the order server, the customer to select at least one of the consumer goods for purchase. The method also includes receiving, by the order server, a request by the customer device to complete an order including the selected consumer goods, receiving, by the order server, a selection of a delivery time for the customer to receive the order at a specified location, and transmitting, by the order server, the order and the selected delivery time to a delivery server. The method further includes receiving, by the delivery server, a delivery acceptance notification issued by a device of a delivery driver indicating that the delivery driver has agreed to deliver the order to the customer. A check-in notification is received by the delivery server indicating that the delivery driver is estimated to arrive at the retail store in less than a threshold amount of time, and the order is automatically placed in a delivery queue for loading the order into the delivery vehicle in response to the check-in notification.

### BRIEF DESCRIPTION OF THE FIGURES

Non-limiting and non-exhaustive embodiments of the present invention are described with reference to the following figures, wherein like reference numerals refer to like parts throughout the various views unless otherwise specified.

FIG. 1 is a schematic illustrating various aspects of a system according to the present disclosure;

FIG. 2 is a schematic illustrating a portion of the system of FIG. 1 in context of order fulfillment and delivery, according to an embodiment of the present invention;

FIG. 3 is a second schematic illustrating a portion of the system of FIG. 1 in context of order fulfillment and delivery, according to an embodiment of the present invention;

FIG. 4 is a schematic illustrating the system of FIG. 1 in a multiple store environment, according to an embodiment of the present invention;

FIG. 5 is a schematic illustrating example components of a server, according to an embodiment of the present invention;

FIG. 6 is a schematic illustrating example components of a handheld device, according to an embodiment of the present invention;

FIG. 7 is a schematic of a handheld device, according to an embodiment of the present invention;

FIG. 8 is a block diagram of a delivery queue that may be used with the system of FIG. 1, according to an embodiment of the present invention; and

FIG. 9 is a flowchart of a method that may be used with the system shown in FIG. 1, according to an embodiment of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis.

With reference to the FIGS. and in operation, the present invention provides a system and method that facilitates tracking and checking in delivery drivers to deliver goods to customers.

In one embodiment, an order server presents a webpage displaying a plurality of consumer goods to a customer for purchase. The customer may select the goods to purchase and may complete the order by checking out the order. The customer may select an option to have the goods delivered to a customer-specified location and may select a delivery window representing a time in which the customer expects the goods to be delivered.

The order and the delivery window are transmitted to a delivery server to arrange delivery of the order. The order and the delivery window are also transmitted to an order assembly server to cause the order to be assembled by one or more store employees. When the order assembly server is notified that the order is assembled, the order assembly server transmits a notification to the delivery server that the order is ready for delivery.

The delivery server arranges for delivery of the order by, for example, transmitting a delivery request to a third party server associated with a third party delivery service. When the delivery server receives a notification from the third party server that the delivery request has been accepted by a delivery driver, the delivery server notifies the order assembly server and/or the store employee that the delivery driver is in transit to the store.

The delivery server receives periodic updates from the third party server to track the real-time location of a delivery vehicle operated by the delivery driver, and to track the estimated time of arrival of the delivery vehicle at the store. When the delivery server determines that the delivery vehicle is less than a threshold amount of time or distance from the store (for example, 10 minutes or 5 miles), the delivery server may automatically add the order to a delivery queue that identifies orders that are getting ready to be loaded onto delivery vehicles.

When the delivery vehicle arrives at a designated parking spot, the delivery server automatically checks in the delivery vehicle at the store by transmitting a notification to the order assembly server and/or to an assembler device operated by the store employee assigned to the order. The store employee may then load the order (i.e., the consumer goods included within the order) into the delivery vehicle without the delivery driver needing to take any action. When the store employee has finished loading the order into the delivery vehicle, the employee uses the assembler device to indicate that the loading of the order is completed. The delivery server or the order assembly server may then transmit a notification to the customer that the order is in transit to the customer-selected location.

Accordingly, the system and method described herein provide an efficient and robust solution to the problem of tracking drivers as the approach the store and checking drivers into retail store fulfillment and loading systems.

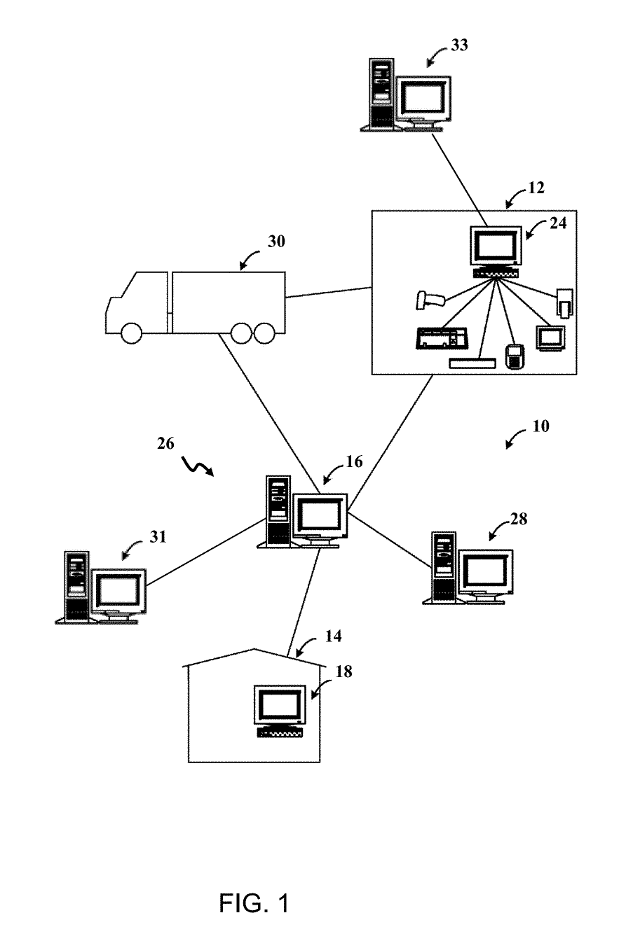

Referring to FIG. 1, an exemplary environment in which the system 10 operates is illustrated. A customer may desire to purchase items from a facility at a specified location, such as a store 12. The store 12 may be representative of a larger corporate environment which may provide many avenues of interface with a customer. In a modern shopping environment, a store 12 may include both one or more brick and mortar retail locations and an on line retail location.

It should be noted that the store 12 may include, or be part of, a plurality of stores 12. The customer, as explained below, may be allowed to choose the store from the plurality of stores 12.

Generally, the customer may desire to order items from the store 12 and have the items (or goods) delivered to a customer-specified location 14 such as the customer's residence, business, other residence, storage lockers, etc. Alternatively, the customer may desire to pick up the order from the store 12.

The system 10, in addition to facilitating the assembly of the order at the store, may be configured to allow or facilitate orders to be efficiently delivered to the customer location 14 or to be picked up at a selected store 12. The customer may desire and request that the order be delivered or picked up the same day that the order is placed or a future day. Furthermore, the customer may request a delivery or pick-up time or window.

For clarity in discussing the various function of the system 10, multiple computers and/or servers are discussed as performing different functions in delivering goods to a customer and receiving customer-owned items from the customer. These different computers (or servers) may, however, be implemented in multiple different ways such as modules within a single computer, as nodes of a computer system, etc. The functions performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

The system 10 may include or have an associated first server such as, for example, an order server 16. The order server 16 may host a store website including one or more web pages which allow a customer to, via a customer device 18, interact with the store 12 and order server 16 to place an order for one or more items or goods from the store 12. Alternatively, the order server 16 may communicate and interact directly with the customer device 18 via appropriate software applications or apps running on the order server 16 and the customer device 18.

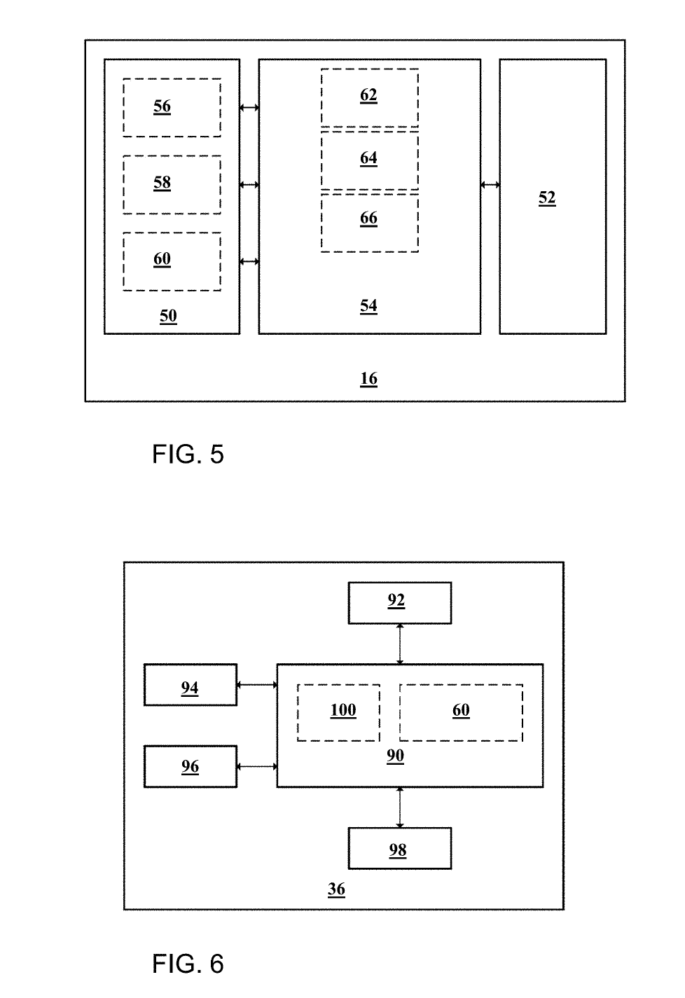

The order server 16 may include a database (shown in FIG. 5) that includes a product list including products, goods, and/or services which are for sale within the store 12 with information relevant to these items. The order server 16 may include software to allow delivery of items to a customer or to facilitate pick-up of the items from the store 12 by the customer. Particularly, the order server 16 may provide an internet webpage to allow a customer to select consumer goods, services offered by the store, select or enter delivery or pick-up information, and purchase the items in a virtual shopping environment. The order server 16 may communicate with other computers, servers, or components of the system 10 to deliver the items to the customer or to arrange for pick-up of the items.

The system 10 may also include a second server such as, for example an order assembly server 24. The order assembly server 24 may interact with the store 12 and assist the store employees in picking items for orders and assembling the order. The order assembly server 24 and other hardware components that may be located at the store or facility may be referred to as an order fulfillment system 26.

The system 10 may also include a third server such as, for example, a delivery server 28. The delivery server 28 may manage delivery routes for a delivery service 30 which delivers goods to and from a customer. The delivery service 30 may be operated by the store or an entity associated with the store, or the delivery service 30 may be a third party service that operates independently of the store.

In an embodiment in which delivery service 30 is a third party service provider, delivery server 28 may communicate with a third party server 33 to communicate order details to the third party server 33 and to receive notifications or messages from the third party server 33 and delivery service 30. For example, in one embodiment, delivery service 30 may be a crowd-sourced driver service that is managed or coordinated by third party server 33. Delivery server 28 may include an application programming interface (API) of third party server 33 that enables delivery server 28 to receive real-time updates regarding whether a delivery request has been accepted, a location of a delivery vehicle, an estimated time of arrival (ETA) of the delivery vehicle at the store, etc.

The delivery server 28 may determine when, during a day, there is sufficient time to deliver an order to the customer and may provide information to the order server 16 to allow the order server 16 to provide customized information to the customer during the ordering process to allow the customer to select a desired delivery window which may be fulfilled by the store 12 and delivery service 30.

A fulfillment window is then selected based on the delivery window or an in-store pick-up window selected by the customer. The fulfillment window represents a time by which a store employee assigned to the order must gather or otherwise assemble the order to ensure that the order is ready to be picked up by the customer during the pick-up window or to ensure that the order is ready to be delivered in time for the delivery window. Accordingly, in embodiments in which the customer has selected in-store pick-up, the fulfillment window may be synonymous with the pick-up window.

The system may also include an appointment server 31. Appointment server 31 receives a notification that the order has been finalized (i.e., that the customer has completed a check out process for the order) and assigns the order to a store employee to fulfill the order. In one embodiment, appointment server 31 manages a workflow or task list of each store employee and may also estimate a time period needed to fulfill each order.

When appointment server 31 receives a notification of a finalized order, appointment server 31 estimates the time needed to fulfill the order and compares the time to the workflow of each employee. Appointment server 31 assigns the order to an employee that is determined to have sufficient time available to fulfill the order by the selected fulfillment window. For example, appointment server 31 or order assembly server 24 may transmit a notification or message to a handheld device operated by the assigned employee with the order details (e.g., the consumer goods or services ordered, the order ID, the customer name and/or ID, the pick-up or fulfillment window, etc.). The message or notification may be displayed on a dashboard or other display of the employee's handheld unit as a pop-up window or similar notification. Appointment server 31 then updates the selected employee's workflow to reflect the assignment of the order and the selected fulfillment window for the order.

In one embodiment, order assembly server 24 may select the fulfillment window based on the estimation of how long it should take for an employee to assemble the order and based on the customer-selected pick-up or delivery window. Alternatively, another suitable server of system 10 may select the fulfillment window based on the same.

Returning to the order process, a customer purchasing items from the store 12 for delivery to a customer location 14 or pick-up at a store 12 will typically view an internet webpage or access an application or app corresponding to the store. The customer may have an account with the store and may sign into the system 10. A customer account may include information about the customer such as a unique customer ID, name, address, past purchase history, etc. The webpage or app may display, to the customer, consumer goods at the store 12 which are available for pick-up or delivery. Not all items may be available for pick-up (at a specific or selected store) or for delivery. The customer may select items or goods for purchase. In signing into an account or entering information for a purchase, the order server 16 may receive (from the customer) customer information which facilitates delivery of goods to the customer. Particularly, the order server 16 may receive the address of the customer-specified location 14 where purchased items are to be delivered. Alternatively, the order server 16 may receive a customer selection of a store 12 at which the customer desires to pick-up the order.

The order server 16 may provide customer information, such as the address of the customer-specified location 14, to the delivery server 28. The delivery server 28 may use the customer information to determine time periods during the day when a delivery service 30 may deliver the items to the customer. The delivery server 28 may manage multiple delivery vehicles/routes throughout the day for the delivery service 30 and may determine how much time a delivery vehicle has available and how much time is required to deliver the items to the customer location 14. The delivery server 28 may determine when during the day a delivery vehicle (or other delivery service) may deliver the items to the customer. The delivery server 28 may provide information regarding when the delivery service 30 is able to deliver items to the customer location 14 to the order server 16. In one embodiment, the order server 16 may generate an order report including a list of purchased goods to be delivered to the customer, and transmit the order report to the delivery server 28 for use in delivering the purchased goods to the customer. In one embodiment, the delivery server 28 may display the delivery report to a delivery operator such as, for example, a delivery vehicle operator or delivery driver, via an operator device such as, for example a delivery device 34 to enable the delivery operator to view the order report.

The order server 16 may then transmit information regarding the order to the store 12, and in particular to the order assembly server 24. The order assembly server 24 may be coupled to, or in communication with, a computer system as well as one or more handheld devices 36 such as, for example, assembler devices 38 to assist store employees in preparing customer orders for delivery. The assembler devices, which may be handheld devices (see below), may provide information to a store employee or assembler, may allow a store employee to scan items, and may allow the assembler(s) to print stickers and/or labels, notices, notes, reports, and/or any suitable tangible medium for those items. The store employee may collect items throughout the store 12 and arrange for those items to be assembled and ready for delivery to one or more customer locations 14 or for pick-up at the store 12.

In one aspect of the invention, the assembler is an employee, i.e., a person, or employees, who utilize the handheld device(s) 36 to assemble the customer order. In another aspect of the present invention, the assembler may be, at least in part, an automatic inventory retrieval system, or AIRS, that automatically retrieves the items from the facility. The AIRS may include one or more robots under control of a suitable controller that is able to read the items in the customer order, retrieve the items from the facility, and place the items in a designated location, such as in a designated bin, in order to facilitate assembly of the customer order. The specific nature, including number and type, of robots required will be dependent upon the layout of the facility, the manner in which the items or goods are stored, and the nature of the items or goods. In some embodiments, of the present invention the assembler devices may be integrated with the AIRS. For purposes of the discussion below, the terms “assembler”, “assembler device” or “handheld device” include (1) an employee/person who utilizes an assembler or handheld device and/or (2) an automated inventory retrieval system (AIRS) with an integrated assembler device.

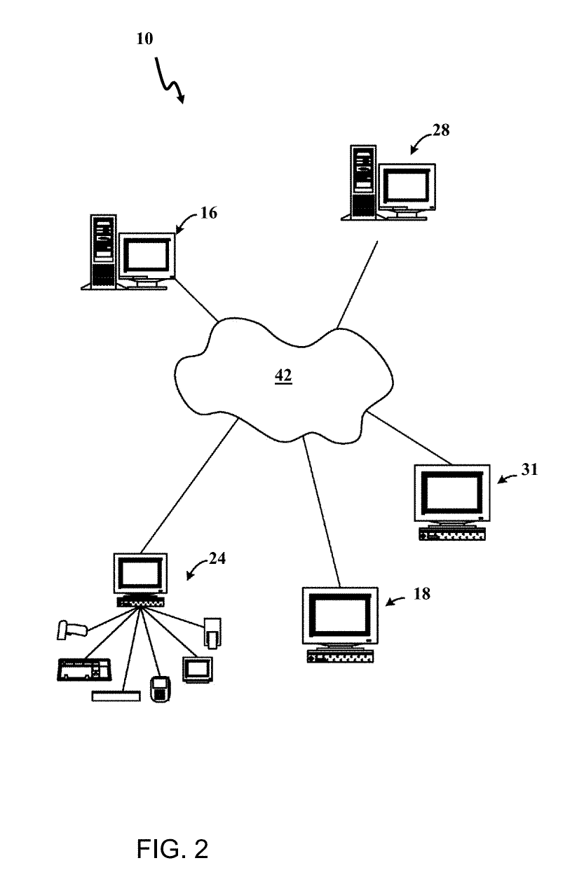

Referring to FIG. 2, in selected embodiments, the software, hardware, and associated components of the system 10 may be programmed and configured to implement one or more embodiments described herein. A customer may communicate with the order server 16 via the customer device 18 and a communications connection or network 42 to select items for purchase. The order server 16 may also communicate with the order assembly server 24, the delivery server 28, and the appointment server 31 via a communications connection 42. The communications connection 42 may be any suitable connection, including the Internet, file transfer protocol (FTP), an Intranet, LAN, a virtual private network (VPN), cellular networks, etc., and may utilize any suitable or combination of technologies including, but not limited to, wired and wireless connections, always on connections, connections made periodically, and connections made as needed.

The customer device 18, delivery device 34, and/or assembler device 38 may include any suitable device, including, but not limited to, a desktop computer, a laptop or notebook computer, a tablet, a handheld mobile device including a cellular telephone, and the like.

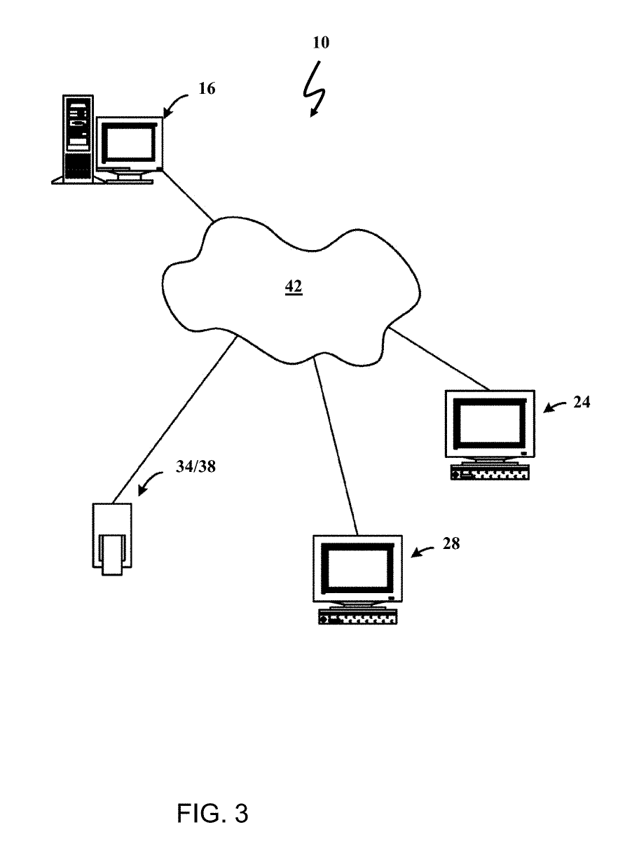

Referring to FIG. 3, in selected embodiments, the hardware, software, or hardware and software of the order server 16, the order assembly server 24, and the delivery server 28 may be configured to receive and utilize item information as described herein, performing functions associated with the order server 16 and order assembly server 24. The order assembly server 24 may communicate with the customer device 18, the delivery device 34, and an assembler device 38 via a communications connection or network 42. In this manner, the various aspects of the system may be exemplified as software, modules, nodes, etc. of a store computer or order assembly server 24.

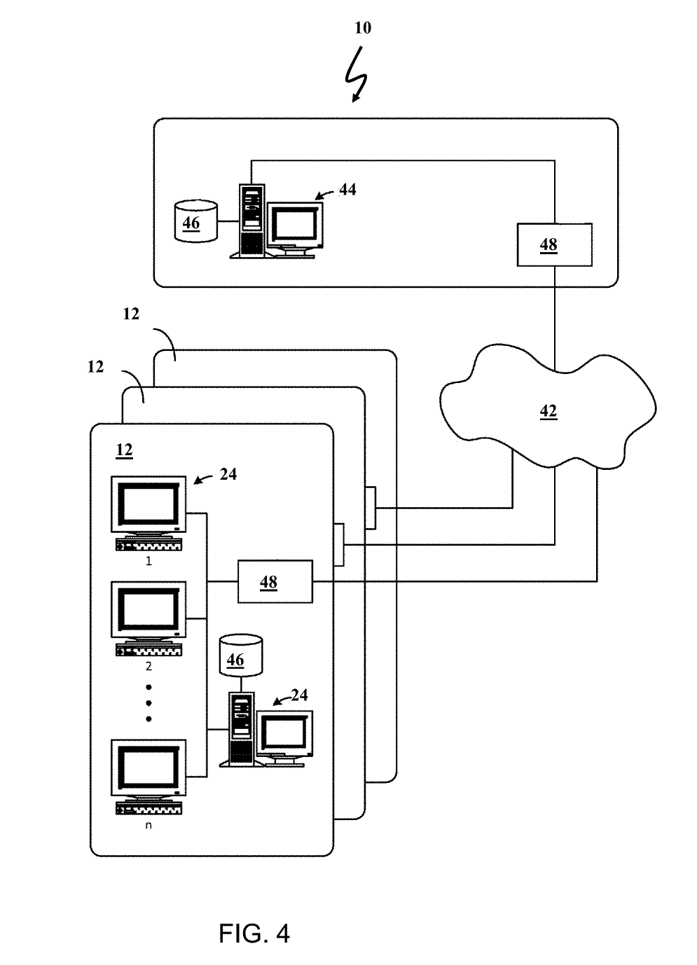

Referring to FIG. 4, in selected embodiments, the system 10 may operate substantially independently, as a stand-alone unit. Alternately, a store system 44 may operate as a larger system. For example, multiple stores 12 may operate at different locations (e.g., different brick-and-mortar stores, facilities, and/or warehouses). In such embodiments, each local system may have an order assembly server 24 as well as other computers or handheld devices 36, database and data storage devices 46, and networking devices 48 as necessary. Each local system may be connected to the order server 16 via a network or internet connection 42. The order server 16 may be associated with database and data storage device 46 and a network device 48 as necessary.

As referenced above, the order server 16 may be configured to perform one or more functions associated with receiving an order from a customer, managing the delivery or pick-up of the customer orders, and streamlining the collection of items for customer orders.

FIG. 5 illustrates an example of the order server 16 configured to perform one or more of the requested functions. In the illustrated embodiment, the order server 16 may include a processing device 50, a communication device 52, and a memory device 54.

The processing device 50 can include memory, e.g., read only memory (ROM) and random access memory (RAM), storing processor-executable instructions and one or more processors that execute the processor-executable instructions. In embodiments where the processing device 50 includes two or more processors, the processors can operate in a parallel or distributed manner. In an example, the processing device 50 may execute a web or application module 56, a delivery module 58, and an order fulfillment module 60.

The communication device 52 is a device that allows the order server 16 to communicate with another device, e.g., the customer device 18, delivery device 34, assembler device 38, etc.

The communication device 52 can include one or more wireless transceivers for performing wireless communication and/or one or more communication ports for performing wired communication.

The memory device 54 is a device that stores data generated or received by the order server 16. The memory device 54 can include, but is not limited to, a hard disc drive, an optical disc drive, and/or a flash memory drive. Further, the memory device 54 may be distributed and located at multiple locations. The memory device 54 is accessible to the processing device 50. In some embodiments, the memory device 54 stores a customer database 62, a consumer product database 64, and a delivery database 66.

In some examples, the customer database 62 can store information associated with a customer. The customer database 62 may, for example, store information associated with a customer account and may include account preferences and customer contact information. The customer database 62 may also store information regarding a customer delivery address as well as specific details regarding delivery of items to the delivery address. The customer database 62 may be queried by the processing device 50 and may provide information to the processing device to facilitate receiving an order from a customer and delivering an order to the customer.

In some examples, the consumer product database 64 stores item information associated with goods and/or products, or types of items in the store 12. For example, the product database 64 may store product lists including product identification codes, UPC codes, item location in the store 12, as well as other information associated with the goods and/or products. By way of example, the product database 64 may be queried by the processing device 50 and may transmit information to the processing device to facilitate the use of item data.

In some examples, the delivery database 66 stores information to facilitate delivery of customer orders to a customer location 14. The delivery database 66 may store information regarding a map of a delivery area or an area around a store 12, street and traffic information for a delivery area, delivery routes, transit times associated with a delivery area, etc.

The processing device 50 may execute the web or application module 56. The web or application module 56 may present a store interface and item information to a customer, receive customer information and order information, and otherwise handle the purchase transaction with a customer as described herein. The processing device 50 may also execute a delivery module 58. The delivery module 58 may receive customer delivery address information from the web or application module 56 and may determine customer the location, compare the location with existing delivery routes, determine available delivery times, schedule deliveries, create delivery routes, and otherwise manage delivery of customer orders. The web or application module 56 may receive potential delivery times from the delivery module 58 and present these potential delivery times to a customer to allow the customer to select a delivery window for their order. The processing device 50 may further close orders for a delivery route, finalize the delivery route, and interface with a delivery service 30 to deliver orders to customers.

The processing device 50 may execute an order fulfillment module 60. The order fulfillment module 60 may receive customer order information for a delivery route and may facilitate the collection of items from a store to fulfill the customer orders. The order fulfillment module 60 may combine orders together, arrange items according to a predetermined picking order through a store 12, and direct a store employee through the store 12 to collect items for the customer orders.

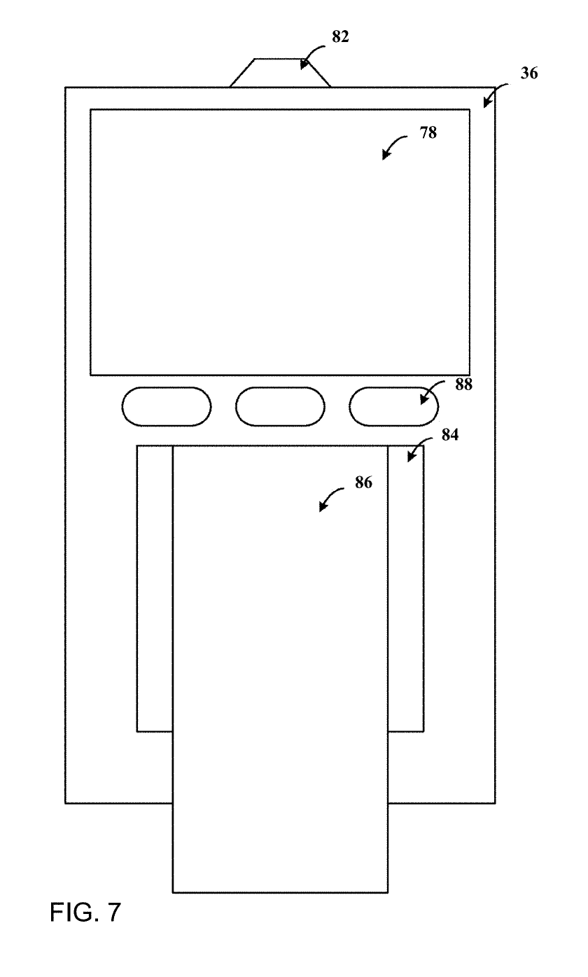

Referring to FIG. 7, a store employee, assembler, and/or delivery personnel may use a handheld computer device 36 while collecting items and/or delivering items for the customer orders. For example, assembler device 38 and/or delivery device 34 may be handheld devices 36 in some embodiments. The handheld device 36 may perform several functions. The handheld device 36 may communicate with the order server 16 and/or the order assembly server 24 to receive a list of items which need to be collected from the store 12 to fulfill the orders. The handheld device 36 may include a display 76 that may present a list of items to the store employee in the order that the employee will encounter the items while following a picking route through the store 12. The display 76 may also present the picking route to the employee, indicating how the employee should progress through the store 12 while collecting items for the customer order(s).

The order server 16 and/or the order assembly server 24 may store item information for all store items which are available for purchase. For example, the order assembly server 24 may store a product identification code for each available store item, the UPC code for each item, item location on the store shelves, and other information as necessary. When a store employee collects an item for the customer orders, the employee may use a scanner 82 on the handheld device 36 to scan the item UPC code. The handheld device 36 may determine if the item is necessary for the customer orders and may indicate whether or not the item is correct to the employee. If correct, the employee may be directed to place the item in a particular collection receptacle or bin for the respective customer order. The handheld device 36 may use a printer 84 to print a sticker label 86 for the item. The sticker label 86 may include a code, barcode, or other machine readable code to identify a particular customer order to which the item pertains. The label 86 may be affixed to the item as the employee collects the item. If desired, the employee may carry multiple boxes, containers, or bins corresponding to the various customer orders and may sort items into the appropriate order receptacle as the items are collected throughout the store 12. It is, however, appreciated that there may often be a sufficient number of customer orders to make it impractical to carry sufficient order receptacles through the store 12. The employee may place items into a single receptacle and bring items to a back area of the store 12 for sorting into different customer orders.

The handheld device 36 may include buttons 88 and other input/output or customer interface devices to permit the store employee and/or delivery personnel to perform the designated functions. The handheld device 36 may also include a communications device to permit the handheld device 36 to communicate with the order server 16 and/or the order assembly server 24, such as by communicating over a store wireless network.

Typically, customer orders are finalized and presented via order assembly server 24 after being finalized. The order assembly server 24 may allow store employees to see customer orders which have not been verified. This may allow store employees to monitor large orders or orders in a period of high demand and, if desired, start to collect items for these orders before the desired pick-up time or scheduled delivery time is finalized to be able to meet the demand.

Referring now to FIG. 6, a schematic showing example components of the handheld device 36 is illustrated. The handheld device 36 may include a processing device 90, a user interface 92, an output device 94, a communication device 96, and a memory device 98. It is noted that the handheld device 36 can include other components and some of the components may not be required in every example.

The processing device 90 can include memory, e.g., read only memory (ROM) and random access memory (RAM), storing processor-executable instructions and one or more processors that execute the processor-executable instructions. In embodiments where the processing device 90 includes two or more processors, the processors can operate in a parallel or distributed manner. The processing device 90 can execute an operating system of the handheld device 36. In the illustrative example, the processing device 90 also executes a software module 100 such as scanning and printing software and an order fulfillment module 60.

The user interface 92 is a device that allows a user, a store employee in particular, to interact with the handheld device 36. While one user interface 92 is shown, the term “user interface” can include, but is not limited to, a touch screen, a physical keyboard, a mouse, a microphone, and/or a speaker. The output device 94 is a device which allows a store employee and/or delivery personnel to output information from the handheld device 36. In particular, the output device 94 may allow a store employee and/or delivery personnel to print delivery order reports and/or labels for store items and associate collected store items with a particular customer order. The communication device 96 is a device that allows the handheld device 36 to communicate with another device, e.g., the order server 16, the order assembly server 24 or the delivery server 28. The communication device 96 can include one or more wireless transceivers for performing wireless communication and/or one or more communication ports for performing wired communication. The memory device 98 is a device that stores data generated or received by the handheld device 36. The memory device 98 can include, but is not limited to, a hard disc drive, an optical disc drive, and/or a flash memory drive. The software module 100 may be stored on the memory device 98 and the order fulfillment module 60 may be created from the software module 100.

The order fulfillment module 60 allows a user, a store employee in particular, to efficiently collect items from a store 12 to fulfill customer orders. The order fulfillment module 60 may execute some or all of the functions described herein to receive one or more customer orders, combine those customer orders, order items in the customer orders sequentially according to a predetermined picking route through the store 12, and guide an employee through the store 12 to collect the items necessary to fulfill the customer orders.

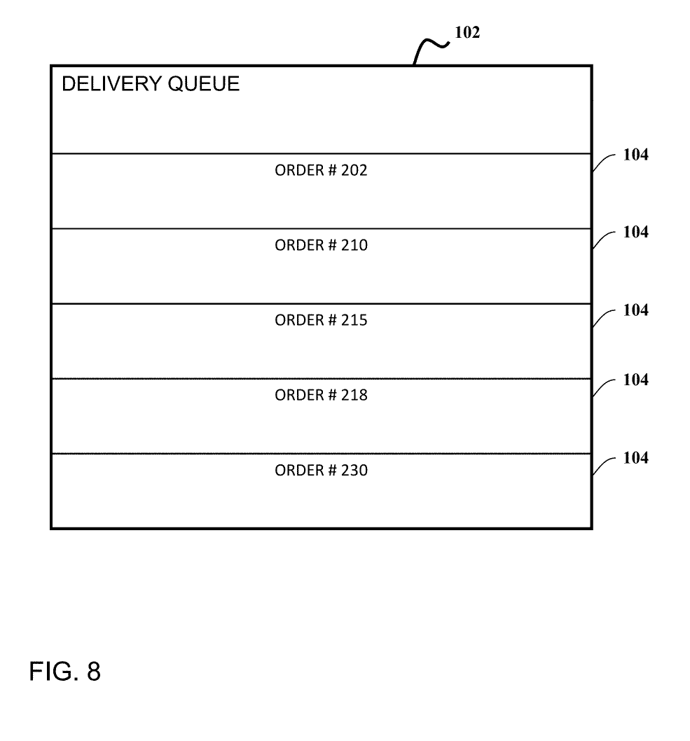

FIG. 8 is a block diagram of an exemplary delivery queue 102 that may be used with system 10. In an exemplary embodiment, delivery queue 102 may be a queue or other data structure that may be stored in a computer-readable memory of one of the servers of system 10. In one embodiment, delivery queue 102 is stored in, and maintained by, order assembly server 24. Alternatively, delivery queue 102 may be stored in, and/or maintained by, delivery server 28 or any other suitable server or device.

In an exemplary embodiment, delivery queue 102 is a first-in-first-out (FIFO) queue that lists orders 104 that are assembled and ready to be loaded onto a delivery vehicle. As each order is assembled, assembler device 38 of a store employee who assembled the order may transmit a notification or message to order assembly server 24 indicating that the order assembly is complete. Order assembly server 24 may then transmit a notification to delivery server 28 that the assembly is complete. Delivery server 28 may automatically add the order 104 (and any associated customer or order details such as the order ID) to the delivery queue 102 when the delivery server 28 receives a notification from a third party server 33 that the delivery vehicle is sufficiently close to the store (e.g., when the vehicle is less than a threshold distance or time from the store). When the delivery vehicle is parked in a designated loading zone or parking space, the order 104 in the delivery queue 102 may be updated to reflect that the vehicle is ready to be loaded. The order items may be loaded onto the delivery vehicle and the order 104 is removed from the delivery queue 102.

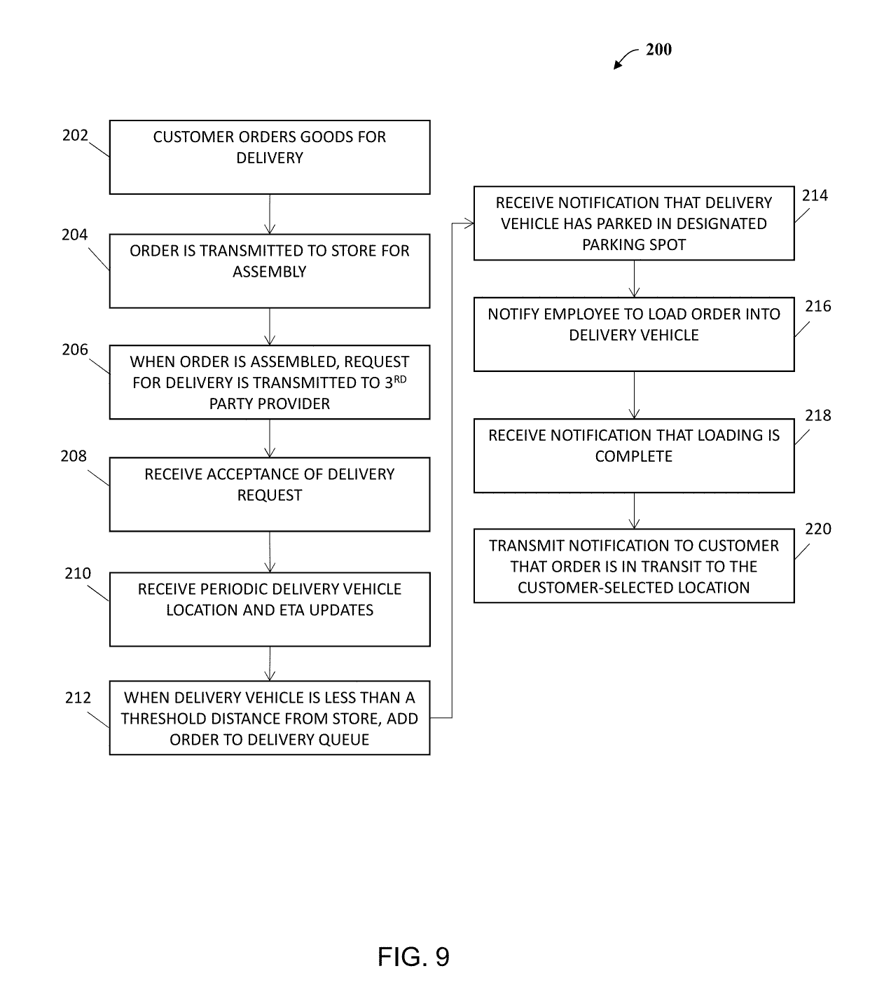

FIG. 9 is a flowchart of a method 200 that may be used with system 10 to deliver items (e.g., consumer goods) from an online order to a customer-selected location 14. Each step of method 200 may be performed independently of, or in combination with, other method steps. Portions of the method may be performed by any one of, or any combination of, the components of the system 10.

In one embodiment, method 200 begins with a customer ordering 202 one or more consumer goods for delivery. The customer may use a customer device 18 to browse a webpage hosted by order server 16 and may select the consumer goods that the customer wants to order. The customer may also select an option to have the ordered goods delivered to a location 14 that the customer selects, and may select a delivery window for when the order should be delivered to the location 14.

When the customer finalizes the order by checking out through the webpage, the order is transmitted 204 to a store for assembly. More specifically, in one embodiment, the order is transmitted 204 to an order assembly server 24 of the store. If the customer selects to have the ordered items delivered to the customer-selected location 14, then order server 16 may select a store that is closest to the customer-selected location 14 and that has all the items in stock. Alternatively, the customer may select a store during the order and checkout process.

The order assembly server 24 receives the order and transmits the order to appointment server 31. The order assembly server 24 may also select a fulfillment window based on the customer-selected delivery window that ensures that the order will be assembled in sufficient time to allow the goods to be delivered to the location 14 by the delivery window. Appointment server 31 assigns a store employee to assemble the order based on a determination that the store employee has sufficient capacity in his or her workflow to assemble the order by the time the fulfillment window arrives. Appointment server 31 may assign the store employee to the order by transmitting a notification or message with the order details to the store employee's assembler device 38.

The store employee may then assemble the order by obtaining the items from the store and placing them in a receptacle or other area in preparation for loading the items into a delivery vehicle. When the order is assembled, assembler device 38 may transmit a notification to order assembly server 24, and order assembly server 24 may transmit a notification to delivery server 28 indicating that delivery of the order is needed.

Delivery server 28 transmits 206 a request for delivery of the order to a third party provider. For example, delivery server 28 may include an API for one or more third party providers of delivery services. Delivery server 28 may use the API to transmit the request for delivery of the order to a third party server 33 of the third party provider along with the location of the store at which the order is waiting. In one embodiment, delivery server 28 may transmit the coordinates or location of a designated loading area or parking spot at or near the store where the delivery vehicle should park so that the store employee can load the order in the most efficient manner.

In turn, the third party server 33 may transmit the request for delivery to a plurality of delivery devices 34 operated by respective delivery drivers. The delivery drivers may have the option to accept the delivery request using the delivery device 34. When a delivery driver has accepted the delivery request, the driver's delivery device 34 may transmit an acceptance notification or message to the third party server 33. Third party server 33 then transmits the acceptance message or notification to delivery server 28 along with the driver details (e.g., the driver's name, the make, model, license plate number, and color of the delivery vehicle, etc.) as well as an estimated time of arrival (ETA) of the delivery driver at the designated parking spot.

Delivery server 28 receives 208 the acceptance notification or message from the third party server 33, and may also receive 210 periodic updates from the third party server 33 of the current location and ETA of the delivery vehicle. Delivery server 28 may transmit the delivery acceptance notification or message to order assembly server 24 and/or appointment server 31 to notify the respective server that the delivery request has been accepted and that the delivery vehicle is in transit to the store. The store employee assigned to the order may also be notified that the vehicle is in transit, for example, by order assembly server 24 or appointment server 31 transmitting a notification to the assembler device 38 operated by the store employee. The notification may cause a pop-up window or other alert to be displayed on the assembler device 38.

Delivery server 28 monitors the location of the delivery vehicle using the periodic updates from the third party server 33. When the delivery server 28 determines that the delivery vehicle is less than a threshold distance or amount of time away from the store or the designated parking spot, the delivery server 28 may automatically “check in” the delivery vehicle and may cause the order to be automatically added 212 to a delivery queue 102. The threshold distance may be, for example, 5 miles away or any other suitable distance. The threshold amount of time may be, for example, 10 minutes away or any other suitable amount of time. The delivery server 28 may set or adjust the threshold distance or amount of time as desired.

In one embodiment, delivery server 28 places the order in the delivery queue 102. Alternatively, delivery server 28 transmits a notification to order assembly server 24 when the vehicle is determined to be less than the threshold distance or amount of time away from the store, and order assembly server 24 automatically places the order in the delivery queue 102. The store employee may also be notified of the delivery vehicle's imminent arrival by a notification received at the assembler device 38 as a result of the order being added to the delivery queue or by a notification or message transmitted from delivery server 28 or order assembly server 24, for example.

When the delivery vehicle arrives at the designated parking spot or loading area, the driver's delivery device 34 transmits a notification to third party server 33, which in turn transmits a notification to delivery server 28 that the delivery vehicle has arrived. Delivery server 28 receives 214 the notification that the vehicle has parked at the designated parking spot and may check-in the vehicle a second time to indicate the arrival of the vehicle. Delivery server 28 notifies 216 the store employee assigned to the order that the vehicle has arrived so that the employee may load the order into the delivery vehicle. For example, delivery server 28 may transmit a notification to assembler device 38, either directly or through order assembly server 24, and the notification may be displayed on the assembler device 38 as a pop-up window or message, for example. When the employee receives the notification, the employee loads the order items into the delivery vehicle at the designated parking spot. When the employee has finished loading the order into the vehicle, the employee may press a button or icon on assembler device 38 that indicates the loading is complete. Assembler device 38 transmits a notification to delivery server 28 either directly or through order assembly server 24 that the loading is complete, and the notification is received 218 at the delivery server 28. In response, delivery server 28 transmits 220 a notification or message to the customer that the order has been loaded and that the delivery vehicle is in transit to the customer-selected location 14. The customer may then receive the order when the delivery vehicle arrives at the location 14.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A system for use in facilitating delivery of a customer order, the system comprising:
a database including a plurality of consumer goods available for purchase by the customer, wherein the consumer goods are available at a retail store;
a delivery server; and
an order server including a processor programmed to:
display a website including the plurality of consumer goods to a customer via a customer device and enable the customer to select at least one of the consumer goods for purchase;
receive a request by the customer device to complete an order including the selected consumer goods;
receive a selection of a delivery time for the customer to receive the order at a specified location; and
transmit the order and the selected delivery time to the delivery server,
wherein the delivery server is configured to:
receive a delivery acceptance notification issued by a device of a delivery driver indicating that the delivery driver has agreed to deliver the order to the customer;
receive a check-in notification indicating that the delivery driver is estimated to arrive at the retail store in less than a threshold amount of time; and
automatically place the order in a delivery queue for loading the order into the delivery vehicle in response to the check-in notification.

2. The system of claim 1, further comprising an order assembly server configured to receive the order from the order server and to cause the order to be assembled by a store employee.

3. The system of claim 2, wherein the delivery server is configured to receive a notification when the order is assembled.

4. The system of claim 3, wherein the delivery server is configured to transmit a delivery request to a third party server that manages a third party delivery service upon receipt of the notification that the order is assembled.

5. The system of claim 4, wherein the delivery server is configured to receive periodic updates from the third party server identifying a location of a delivery vehicle operated by the delivery driver and an estimated time of arrival of the delivery vehicle at the store.

6. The system of claim 5, wherein the delivery server is configured to receive a notification from the third party server when the delivery vehicle has parked in a parking spot designated by the delivery server.

7. The system of claim 6, wherein the delivery server is configured to transmit a notification to an assembler device of the store employee in response to the notification that the delivery vehicle has parked in the designated parking spot.

8. The system of claim 7, wherein the delivery server is configured to receive a notification when the store employee has loaded the order in the delivery vehicle.

9. The system of claim 8, wherein the delivery server is configured to transmit a notification to the customer that the order is in transit to the specified location in response to the notification that the employee has loaded the order into the delivery vehicle.

10. The system of claim 1, wherein a store employee is assigned to assemble the order, and wherein the store employee operates an assembler device that receives a notification when the order is added to the delivery queue.

11. A method for facilitating delivery of a customer order, the method comprising:
providing a database including a plurality of consumer goods available for purchase by the customer, wherein the consumer goods are available at a retail store;
displaying, by an order server, a website including the plurality of consumer goods to a customer via a customer device;
enabling, by the order server, the customer to select at least one of the consumer goods for purchase;
receiving, by the order server, a request by the customer device to complete an order including the selected consumer goods;
receiving, by the order server, a selection of a delivery time for the customer to receive the order at a specified location;
transmitting, by the order server, the order and the selected delivery time to a delivery server,
receiving, by the delivery server, a delivery acceptance notification issued by a device of a delivery driver indicating that the delivery driver has agreed to deliver the order to the customer;
receiving, by the delivery server, a check-in notification indicating that the delivery driver is estimated to arrive at the retail store in less than a threshold amount of time; and
automatically place the order in a delivery queue for loading the order into the delivery vehicle in response to the check-in notification.

12. The method of claim 11, further comprising receiving, by an order assembly server, the order from the order server and causing the order to be assembled by a store employee.

13. The method of claim 12, further comprising receiving, by the delivery server, a notification when the order is assembled.

14. The method of claim 13, further comprising transmitting, by the delivery server, a delivery request to a third party server that manages a third party delivery service upon receipt of the notification that the order is assembled.

15. The method of claim 14, further comprising receiving, by the delivery server, periodic updates from the third party server identifying a location of a delivery vehicle operated by the delivery driver and an estimated time of arrival of the delivery vehicle at the store.

16. The method of claim 15, further comprising receiving, by the delivery server, a notification from the third party server when the delivery vehicle has parked in a parking spot designated by the delivery server.

17. The method of claim 16, further comprising transmitting, by the delivery server, a notification to an assembler device of the store employee in response to the notification that the delivery vehicle has parked in the designated parking spot.

18. The method of claim 17, further comprising receiving, by the delivery server, a notification when the store employee has loaded the order in the delivery vehicle.

19. The method of claim 18, further comprising transmitting, by the delivery server, a notification to the customer that the order is in transit to the specified location in response to the notification that the employee has loaded the order into the delivery vehicle.

20. The method of claim 11, further comprising assigning a store employee to assemble the order using an assembler device, and receiving a notification on the assembler device when the order is added to the delivery queue.
